(19) United States
(12) Patent Application Publication
(10) Pub. No.: US 2008/0229635 A1
(43) Pub. Date: Sep. 25, 2008

(54) Motor vehicle license plate holder accessory for displaying decals and the like

(76) Inventor: Nicholas Soldo, Kings Park, NY (US)

Correspondence Address: Thomas M. Galgano, Esq.;GALGANO & ASSOCIATES, PLLC, Suite 204, 20 W. Park Avenue, Long Beach, NY, 11561, US

(21) Appl. No.: 11/725,334

(22) Filed: Mar. 19, 2007

(51) Int. Cl. G09F 21/04

(52) U.S. Cl. 40/210

(57) ABSTRACT

A display panel for attachment to a license plate holder having a plurality of mounting holes. The holes are dimensioned and located to align with one or more of the mounting holes of a standard U.S. license plate. The panel is installed by aligning at least one of its mounting holes with the holes in the license plate and then mounting the license plate with the display panel partially behind it on a license plate holder. The panel has an exposed portion that laterally flanks the license plate. A method for mounting the display panel and a kit employing the display panel are also disclosed.

### BACKGROUND OF THE INVENTION

1. Field of the Invention

This invention relates broadly to motor vehicle accessories. More particularly, this invention relates to a motor vehicle license plate holder accessory for displaying decals and the like.

2. Brief Description of the Prior Art

For many years it has been necessary to apply various decals and/or stickers to an automobile to identify compliance with a law, membership in an organization, or payment of a fee. Examples of such identifications include the pre-paid use of a parking facility, entrance to a club, park or beach, payment of a toll, etc. For many years it has also been desirable, though not necessary, to apply various indicia to a motor vehicle for personal reasons. Such indicia include sports logos, political statements, indicia of a school, charitable organization, or employer.

Generally, most motor vehicles are passed on to another owner after the first owner replaces the vehicle with a newer one. Indeed, many motor vehicles may have several owners during the useful life of the vehicle. With the current popularity of leasing motor vehicles, relatively new vehicles change hands rapidly.

While in the past, many people applied such stickers and decals to the vehicles windows, that is no longer necessarily the case. For some time now, motor vehicles, both domestic and foreign, have provided license plate space which is large enough to accommodate the longer plates that are used in most countries outside North America. In 1956, all North American passenger vehicle license plates, except for French controlled St. Pierre and Miquelon, were standardized at a size of six inches tall by twelve inches wide. The horizontal and vertical location of four mounting holes was also standardized. The vertical spacing of the holes is four and three quarter inches. The European Union, on the other hand, has two standards: twenty and one half inches by four and one third inches or thirteen and three eighths inches by eight and two thirds inches. The former is generally used for cars and the latter is used for trucks.

Thus, when a U.S. license plate is affixed to the vehicle, several inches of flat painted vehicle body flank each side of the narrower U.S. license plate. See, e.g., prior art FIG. 1 which shows a portion of the rear end of a vehicle 1 with a New York license plate 2 applied to the four mounting holes (not shown) of the license plate holder 3 via four screws 4. The additional spaces 5 and 6 to the left and the right of the license plate 2 are provided by the vehicle manufacturer to accommodate the wider license plates used in the many countries outside North America. People in the U.S. have found these spaces, which can be up to eight inches on each side of the U.S. plate, an ideal place to put the above described decals and stickers. One reason for doing so is that placing these decals and stickers on windows tends to obstruct vision.

A well established disadvantage of applying decals and/or stickers to a motor vehicle is that they are difficult to remove, even when placed on windows. Moreover, if they are applied to a painted part of the vehicle, removal may damage the paint.

If these decals or stickers are left on the vehicle, they may impair the value of the vehicle to subsequent owners. For example, it would be difficult to sell a vehicle with a NY Yankees sticker next to the license plate to a Boston Red Sox fan or even a NY Mets fan. In addition, and more seriously, stickers or decals which represent the expenditure of money, such as those that permit entry to clubs, parking, beaches, and the like must be removed lest the owner forfeit the value paid and/or grant permission to someone who is not entitled. More often than not, removal of a sticker or decal essentially destroys it or at least destroys its ability to be conveniently affixed to a new vehicle. A replacement sticker or decal might be obtainable upon the surrender of the damaged one, but this could be time consuming, particularly with respect to governmentally issued stickers and decals. During the period awaiting replacement, the owner of the damaged sticker or decal is deprived of the privilege it had afforded. This could be a particularly acute problem for people who short term lease expensive cars and are members of several exclusive organizations.

### SUMMARY OF THE INVENTION

It is therefore an object of the invention to provide a means for attaching stickers and decals to a motor vehicle in such a manner that they are easily removed.

It is another object of the invention to provide a means for attaching stickers and decals to a motor vehicle in such a manner that they do not damage the vehicle's paint when they are removed.

It is a further object of the invention to provide a means for attaching stickers and decals to a motor vehicle in such a manner that they are easily transferred to another vehicle.

Certain of the foregoing and related objects are attained according to the invention by the provision of a display panel for a license plate holder of the type having at least a pair of spaced-apart mounting holes for mounting a license plate thereon via at least a pair of removable fasteners, comprising: at least one, generally planar side flap having a plurality of spaced-apart mounting holes alignable with at least one of said mounting holes of said license plate holder to permit mounting of said side flap on said license plate holder with a portion of said side flap disposed between the license plate and the license plate holder via one of the same license plate holder mounting holes and fastener used to mount the license plate on said license plate holder, said plurality of mounting holes of said side flap permitting adjustment of the degree to which said side flap extends laterally outward from a side of said license plate holder. Preferably, a pair of said side flaps are provided which are laterally extendable from opposite sides of said license plate holder.

Desirably, said side flap comprises a rectangular sheet of plastic having first and second vertical sides each having a first length and first and second horizontal sides each having a second length and front and back surfaces and wherein said plurality of spaced apart mounting holes extend through said front and back surfaces of said rectangular sheet of plastic, each mounting hole corresponding in diameter to the diameter of a mounting hole of a standard license plate, a first of said plurality of holes being located adjacent to one of said horizontal sides and one of said vertical sides. A rubber pad is advantageously affixed to the back surface of said sheet of plastic. The plurality of spaced apart mounting holes are preferably horizontally spaced apart.

In a preferred embodiment, said plurality of spaced apart mounting holes includes two sets of horizontally spaced apart mounting holes, one set located adjacent to one of said horizontal sides and the other set located adjacent to the other of said horizontal sides. Most desirably, said plurality of spaced apart holes includes two vertically spaced apart holes which are spaced apart the same distance as the distance between upper and lower mounting holes of a standard license plate. Most advantageously, said two sets of horizontally spaced apart holes are vertically spaced apart the same distance as the distance between upper and lower mounting holes of a standard license plate. The first length is preferably between five and six inches and said second length is preferably between eight and nine inches.

Certain of the foregoing and related objects are also attained according to the invention by the provision of a method of displaying a decal adjacent to a license plate mounted on a motor vehicle, said method comprising: locating a license plate holder having at least a pair of spaced-apart mounting holes for mounting a license plate thereon via at least a pair of removable fasteners on the motor vehicle; placing at least one generally planar side flap having a plurality of horizontally spaced apart holes over at least a portion of said license plate holder; aligning one of said holes of said side flap with one of said mounting holes in the license plate holder; positioning a license plate on said license plate holder so that at least one of said mounting holes thereof is aligned with said one of said holes of said side flap aligned with one of said mounting holes of said license plate holder; inserting a removable fastener through said aligned holes and fastening the license plate side flap and license plate via said fastener to said license plate holder with at least a portion of said side flap extending laterally outward from a side of said license plate holder which defines an exposed portion; and affixing a decal to said exposed portion of said side flap.

The method further preferably comprises the step of: prior to fastening the license plate and side flap to the license plate holder, affixing a rubber pad to a back surface of said side flap. In a preferred embodiment wherein said side flap comprises a first rectangular sheet of plastic has two vertically spaced apart holes, said method further comprises the steps of: aligning both vertically spaced apart holes to license plate mounting holes; and attaching the license plate and first rectangular sheet of plastic to the license plate holder with removable fasteners comprising a pair of screws, one through each of the vertically spaced apart holes.

In a further preferred embodiment wherein a second side flap comprises a second rectangular sheet of plastic having at least two spaced apart holes, each hole having a diameter corresponding to the diameter of the mounting holes of the license plate, said method further comprises the step of: aligning the second rectangular sheet of plastic relative to the license plate such that at least one of its holes is aligned with a mounting hole in the license plate and the second rectangular sheet of plastic extends horizontally away from the other side of the license plate; placing a screw through the aligned holes and attaching the second rectangular sheet of plastic and screwing it to the license plate holder; and affixing a decal to said first and second rectangular sheets of plastic. Most desirably, said step of aligning includes aligning the first rectangular sheet of plastic between the license plate and the license plate holder. Most advantageously, both steps of aligning include aligning both rectangular sheets of plastic between the license plate and the license plate holder.

Certain of the foregoing and related objects are also attained according to the invention by the provision of a license plate holder accessory, comprising: a generally planar side flap comprising a rectangular sheet of plastic having first and second vertical sides each having a first length, and first and second horizontal sides each having a second length, and front and back surfaces, and a plurality of spaced apart mounting holes in said rectangular sheet of plastic, each mounting hole corresponding in diameter to the diameter of a mounting hole of a standard U.S. license plate, a first of said plurality of holes being located adjacent to one of said horizontal sides and one of said vertical sides. Preferably, a rubber pad affixed to the back surface. Advantageously, said plurality of spaced apart mounting holes are horizontally spaced apart. Most desirably, said plurality of spaced apart mounting holes includes two sets of horizontally spaced apart mounting holes, one set located adjacent to one of said horizontal sides and the other set located adjacent to the other if said horizontal sides.

In a preferred embodiment, said plurality of spaced apart holes includes two vertically spaced apart holes which are spaced apart the same distance as the distance between upper and lower mounting holes of a standard U.S. license plate. Most desirably, said two sets of horizontally spaced apart holes are vertically spaced apart the same distance as the distance between upper and lower mounting holes of a standard U.S. license plate. Most advantageously, said first length is between five and six inches and said second length is between eight and nine inches.

Certain of the foregoing and related objects are also attained according to the present invention by the provision of a kit for displaying decals on a motor vehicle of the type having a license plate holder having at least a pair of spaced-apart mounting holes for mounting a license plate thereon via at least a pair of removable fasteners, comprising; a pair of generally planar, side flaps each having a plurality of spaced-apart mounting holes alignable with at least one of said mounting holes of said license plate holder to permit mounting of said side flaps on said license plate holder with a portion of said side flaps disposed between the license plate and the license plate holder via one of the same license plate holder mounting holes and fastener used to mount the license plate on said license plate holder, said plurality of mounting holes of said side flaps permitting adjustment of the degree to which said side flaps extends laterally outward from opposite sides of said license plate holder. The kit preferably includes a pair of self-adhesive rubber pads and/or a plurality of decals.

In a preferred embodiment, the kit comprises two rectangular sheets of plastic each having first and second vertical sides each having a first length and first and second horizontal sides each having a second length and front and back surfaces and a plurality of spaced apart mounting holes in said rectangular sheet of plastic, each mounting hole corresponding in diameter to the diameter of a mounting hole of a standard U.S. license plate, a first of said plurality of holes being located adjacent to one of said horizontal sides and one of said vertical sides; and two self adhesive rubber pads, each dimensioned to be affixed to the back surface of one of said rectangular sheets of plastic. Preferably, the kit also comprises a plurality of decals.

Additional objects and advantages of the invention will become apparent to those skilled in the art upon reference to the detailed description taken in conjunction with the provided figures.

### BRIEF DESCRIPTION OF THE DRAWINGS

FIG. 1 is a broken rear elevation view of a prior art motor vehicle showing a license plate mounted on a license plate holder with body panel spaces flanking the plate on both sides;

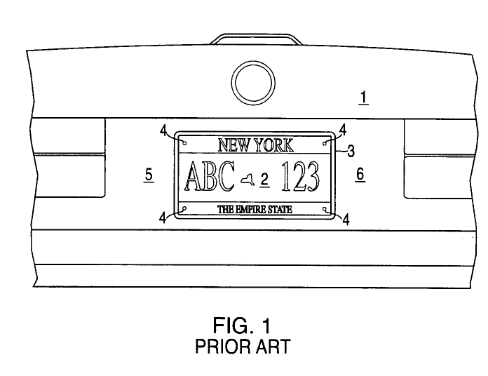

FIG. 2 is a perspective view of a plastic display panel according to the invention; and

FIG. 3 is a broken rear elevation view of a motor vehicle with two display panels according to the invention installed, one on each side of the license plate and with sports stickers applied to each of the plastic panels.

### DETAILED DESCRIPTION OF THE PREFERRED EMBODIMENTS

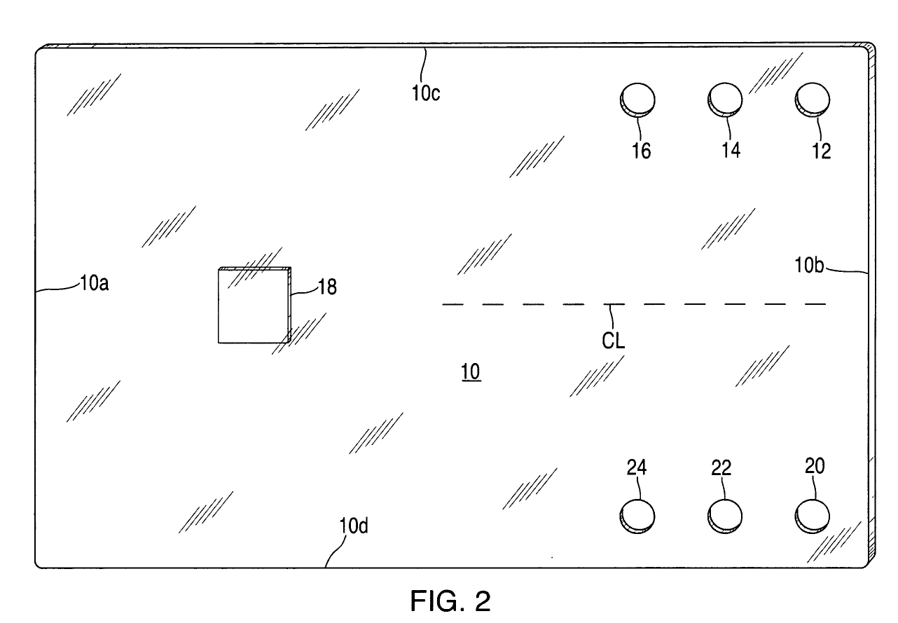

Turning now to FIG. 2, a decal/sticker display panel 10 according to the invention is illustrated (at a preferred one-to-one scale) and it comprises a planar, preferably rectangular, side flap of relatively rigid plastic defining two vertical sides 10a and 10b and two horizontal sides 10c and 10d. The vertical sides 10a and 10b have a vertical dimension similar to that of a standard U.S. license plate, e.g. five and one half inches. In the presently preferred embodiment, the horizontal sides have a horizontal dimension of eight and three quarter inches and the plate 10 is preferably one eighth to three eighths of an inch thick. Suitable plastics may include polypropylene and polyvinyl chloride.

The panel 10 is provided with a plurality of spaced apart holes, e.g., 12, 14, 16, each having a diameter corresponding to the diameter of the mounting holes of a standard U.S. license plate, i.e., three eighths of an inch in diameter. According to the presently preferred embodiment, the holes 12, 14, 16 are spaced two and seven eighths inches from the centerline CL of the panel 10, and three quarters of an inch from each other. The hole 12 is spaced one half inch from the vertical side 10b of the plate. Thus, the first hole 12 is located adjacent to a vertical side and a horizontal side.

According to the presently preferred embodiment, a three quarter inch adhesive backed rubber pad 18 is preferably affixed to the rear of the plate 10 in the center of the half of the panel where no holes are located, as shown in FIG. 2. The presently preferred embodiment provides three additional holes 20, 22, 24 which are located near the lower horizontal side 10d of the panel 10. The holes 20, 22, 24 are dimensioned and located in the same way as the holes 12, 14, 16 but they are spaced down from the center line CL rather than up from it.

It should be appreciated that although license plates are provided with four mounting holes, they are often mounted to a vehicle using only the top two holes. Thus, it may not be necessary to provide two sets of holes (upper and lower) as shown in FIG. 2. However, there are two good reasons for providing upper and lower holes. First, if only one screw is used to mount the panel 10, if the screw loosens, the plate could droop and potentially scratch the vehicle body paint. Second, the adhesive backed rubber pad 18 is preferably shipped with the plate as a user-installable item with instructions to peel the paper covering off the adhesive back and affix the pad 18 to the back of the panel 10. If the user mistakenly affixes the pad to the wrong side of the panel 10, it can be reoriented by simply turning the panel upside down and the mounting holes will all be in the relatively same location. Thus, the embodiment shown in FIG. 2 is the presently preferred embodiment having three upper holes and three lower holes. A second, less preferred embodiment has only one set of three holes. Other embodiments may be provided with more or fewer holes.

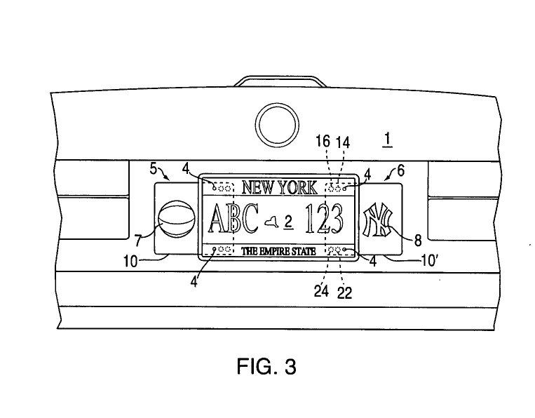

From the foregoing, it should be appreciated that the panel 10 shown in FIG. 2 can be installed on the left or right side of a license plate by rotating it one hundred eighty degrees. FIG. 3 shows two panels 10, 10′ attached on opposite sides of the license panel 2 of the vehicle 1. In particular, and as seen best in FIG. 3, panels 10, 10′ are partially sandwiched (as shown in phantom line) between the license plate holder 3 and license plate 2 via the four screws 4 which are each inserted through one of the holes in the license plate 2 as well as one of the aligned mounting holes, e.g., hole 12 of the panels 10 and 10′ and, in turn, into the corresponding aligned holes in the license plate holder (not shown) which typically have a threaded nut fastener affixed adjacent its mounting holes to receive the fastened screws 4. The panel 10 overlies the space 7 on the left hand side of the license panel 2. The plate 10′ overlies the space 8 on the right side of the license panel 2. The panel 10 is illustrated with a sticker 7 applied to it and the panel 10′ is illustrated with a decal 8 applied to it. As can be appreciated, the plurality of holes 12, 14, and 16 allows for lateral adjustment of the panels 10, 10″ to permit one to adjust the amount the exposed portions of the display panels extend outwardly and laterally of the license plate 2 and license plate holder 3.

The panels 10, 10′ are easily removable from the vehicle 1 by removing the license plate 2, which needs to be done anyway when ownership of the vehicle is transferred. Similarly, the panels 10, 10′ are easily installed on a new vehicle when the license plates are installed, which also needs to be done anyway when a new vehicle is purchased or leased. Sticker 7 and decal 8 applied to the panels 10, 10′ will not come in contact with any part of the vehicle 1.

The invention may be sold as a kit which includes two plastic side flaps with preformed holes, a pair of self-adhesive rubber pads, one for each flap, and instructions. Optionally, the kit may further include a plurality of stickers, decals, or the like. The stickers, decals, or the like may consist of parking permits, logos of local sports teams, college symbols, or political or inspirational statements. In the case of sports teams, the kit can be packaged differently for different states with stickers/decals with logos of teams from the state included. In the case of college symbols, the kit can be packaged differently for different colleges with the stickers/decals selected accordingly. Similarly, a kit can be packaged differently for sale by different political, religious, civic, fraternal, or other types of organizations.

There have been described and illustrated herein several embodiments of a motor vehicle license plate holder accessory for displaying stickers, decals, and the like. While particular embodiments of the invention have been described, it is not intended that the invention be limited thereto, as it is intended that the invention be as broad in scope as the art will allow and that the specification be read likewise.

Thus, while particular plastic materials have been disclosed, it will be appreciated that other materials as well as differently sized materials could be used as well to suit a particular application. In addition, while the presently preferred embodiment may be made from clear plastic, an alternate embodiment could be made of opaque or translucent plastic. The opaque plastic could be provided with a color which matches the color of the vehicle body paint. Alternatively, opaque plates could be provided with a contrasting color. Furthermore, although the display panels or side flaps are preferably rectangular, other shapes could be employed.

Since in some vehicles the license plate holder is a separate piece removable from the body of the vehicles, but in other vehicles it is integral to the body and may merely consist of two or four threaded holes in a body panel, the term “license plate holder” as used herein should be interpreted broadly to encompass all of these different arrangements. Similarly, the term “decals” as used herein should be interpreted broadly to encompass decals, stickers or the like, i.e., anything that could be displayed on the display panels. It will therefore be appreciated by those skilled in the art that yet other modifications could be made to the provided invention without deviating from its spirit and scope from the invention as claimed.

1. A license plate display panel accessory assembly comprising:
a license plate having at least one mounting hole;
at least one removable fastener;
a license plate holder of the type having at least one mounting hole for mounting said license plate thereon via said at least one removable fastener; and
at least one, generally planar side flap which laterally extends from a side of said license plate holder, wherein said side flap has a plurality of spaced-apart mounting holes alignable with said at least one mounting hole of said license plate holder to permit mounting of said side flap on said license plate holder with a portion of said side flap disposed between said license plate and said license plate holder via the same license plate holder mounting hole and fastener used to mount said license plate on said license plate holder, said plurality of mounting holes of said side flap permitting adjustment of the degree to which said side flap extends laterally outward from a side of said license plate holder.

2. A license plate display panel accessory assembly according to claim 1, wherein:
a pair of said side flaps are provided which are laterally extendable from opposite sides of said license plate holder.

3. A license plate display panel accessory assembly according to claim 2, wherein:
said side flap comprises a rectangular sheet of plastic having first and second vertical sides each having a first length and first and second horizontal sides each having a second length and front and back surfaces and wherein said plurality of spaced apart mounting holes extend through said front and back surfaces of said rectangular sheet of plastic, each mounting hole corresponding in diameter to the diameter of a mounting hole of said license plate, a first of said plurality of holes being located adjacent to one of said horizontal sides and one of said vertical sides.

4. A license plate display panel accessory assembly according to claim 3, further comprising:
a rubber pad affixed to the back surface of said sheet of plastic.

5. A license plate display panel accessory assembly according to claim 3, wherein:
said plurality of spaced apart mounting holes are horizontally spaced apart.

6. A license plate display panel accessory assembly according to claim 31, wherein:
said plurality of spaced apart mounting holes includes two sets of horizontally spaced apart mounting holes, one set located adjacent to one of said horizontal sides and the other set located adjacent to the other of said horizontal sides.

7. A license plate display panel accessory assembly according to claim 31, wherein:
said plurality of spaced apart holes includes two vertically spaced apart holes which are spaced apart the same distance as the distance between said upper and lower mounting holes of said license plate.

8. A license plate display panel accessory assembly according to claim 6, wherein:
said two sets of horizontally spaced apart holes are vertically spaced apart the same distance as the distance between said upper and lower mounting holes of said license plate.

9. A license plate display panel accessory assembly according to claim 3, wherein:
said first length is between five and six inches and said second length is between eight and nine inches.

10. A method of displaying a decal adjacent to a license plate mounted on a motor vehicle, said method comprising:
locating a license plate holder having at least a pair of spaced-apart mounting holes for mounting a license plate thereon via at least a pair of removable fasteners on the motor vehicle;
placing at least one generally planar side flap having a plurality of horizontally spaced apart holes over at least a portion of said license plate holder;
aligning one of said holes of said side flap with one of said mounting holes in the license plate holder;
positioning a license plate on said license plate holder so that at least one of said mounting holes thereof is aligned with said one of said holes of said side flap aligned with one of said mounting holes of said license plate holder;
inserting a removable fastener through said aligned holes and fastening the license plate side flap and license plate via said fastener to said license plate holder with at least a portion of said side flap extending laterally outward from a side of said license plate holder which defines an exposed portion; and
affixing a decal to said exposed portion of said side flap.

11. A method according to claim 10, further comprising the step of:
prior to fastening the license plate and side flap to the license plate holder, affixing a rubber pad to a back surface of said side flap.

12. A method according to claim 10, wherein said side flap comprises a first rectangular sheet of plastic has two vertically spaced apart holes, said method further comprising the steps of:
aligning both vertically spaced apart holes to license plate mounting holes; and
attaching the license plate and first rectangular sheet of plastic to the license plate holder with removable fasteners comprising a pair of screws, one through each of the vertically spaced apart holes.

13. A method according to claim 12, wherein a second side flap comprises a second rectangular sheet of plastic having at least two spaced apart holes, each hole having a diameter corresponding to the diameter of the mounting holes of the license plate and said method further comprises the step of:
aligning the second rectangular sheet of plastic relative to the license plate such that at least one of its holes is aligned with a mounting hole in the license plate and the second rectangular sheet of plastic extends horizontally away from the other side of the license plate;
placing a screw through the aligned holes and attaching the second rectangular sheet of plastic and screwing it to the license plate holder; and
affixing a decal to said first and second rectangular sheets of plastic.

14. A method according to claim 12, wherein:
said step of aligning includes aligning the first rectangular sheet of plastic between the license plate and the license plate holder.

15. A method according to claim 13, wherein:
both steps of aligning include aligning both rectangular sheets of plastic between the license plate and the license plate holder.

16. A license plate holder accessory assembly, comprising:
a license plate having opposite lateral sides and at least a pair of mounting holes;
at least a pair of removable fasteners;
a license plate holder having at least a pair of spaced-apart mounting holes; and
a pair of generally planar side flaps, each of which laterally extends from an opposite side of said license plate holder, and wherein each side flap comprises a rectangular sheet of plastic having first and second vertical sides each having a first length, and first and second horizontal sides each having a second length, and front and back surfaces, and a plurality of spaced apart mounting holes in said rectangular sheet of plastic, each mounting hole in said rectangular sheet of plastic corresponding in diameter to the diameter of said mounting holes of said license plate, a first of said plurality of holes being located adjacent to one of said horizontal sides and one of said vertical sides.

17. A license plate holder accessory assembly according to claim 16, further comprising:
a rubber pad affixed to the back surface.

18. A license plate holder accessory assembly according to claim 32, wherein:
said plurality of spaced apart mounting holes are horizontally spaced apart.

19. A license plate holder accessory assembly according to claim 16, wherein:
said plurality of spaced apart mounting holes includes two sets of horizontally spaced apart mounting holes, one set located adjacent to one of said horizontal sides and the other set located adjacent to the other if said horizontal sides.

20. A license plate holder accessory assembly according to claim 32, wherein:
said plurality of spaced apart holes includes two vertically spaced apart holes which are spaced apart the same distance as the distance between said upper and lower mounting holes of said license plate.

21. A license plate holder accessory assembly according to claim 18, wherein:
said two sets of horizontally spaced apart holes are vertically spaced apart the same distance as the distance between said upper and lower mounting holes of said license plate.

22. A license plate holder accessory assembly according to claim 16, wherein:
said first length is between five and six inches and said second length is between eight and nine inches.

23-27. (canceled)

28. A license plate display panel accessory assembly according to claim 1, wherein:
said license plate is one-piece.

29. A license plate holder accessory assembly according to claim 16, wherein:
said license plate is one-piece.

30. A license plate display panel accessory assembly according to claim 1, wherein:
said license plate holder has at least a pair of spaced apart mounting holes for mounting said license plate thereon and said assembly has at least a pair of removable fasteners for mounting said license plate on said license plate holder via said pair of removable fasteners.

31. A license plate display panel accessory according to claim 1, wherein:
said license plate has an upper and lower mounting hole.

32. A license plate holder accessory assembly according to claim 16, wherein:
said license plate has an upper and lower mounting hole.
